(19) United States
(12) Patent Application Publication
(10) Pub. No.: US 2003/0015997 A1
(43) Pub. Date: Jan. 23, 2003

(54) Startup and current control of a merge boost and polarity inverting swiched power supply

(76) Inventor: James E. Chloupek, Plano, TX (US)

Correspondence Address: TEXAS INSTRUMENTS INCORPORATED, P O BOX 655474, M/S 3999, DALLAS, TX, 75265

(21) Appl. No.: 10/165,298

(22) Filed: Jun. 7, 2002

Related U.S. Application Data
(60) Provisional application No. 60/302,095, filed on Jun. 29, 2001.

(51) Int. Cl. G05F 1/613

(52) U.S. Cl. 323/225

(57) ABSTRACT

A power supply circuit for generating regulated voltages includes a storage circuit to store the voltages, a control circuit to control the level of stored voltage, and a pump circuit to shift the input voltage to a higher voltage and detection circuit to disable current limit sensing from ending the charge cycle if the output regulated voltage is low.

### FIELD OF THE INVENTION

The present invention relates to switching power supplies which use an inductor, and more particularly to a merged boost and polarity inverting switching power supplies in hard disk drives.

### BACKGROUND OF THE INVENTION

The positive boost switching power supplies typically includes an inductor which has the supply end connected to a power source, with the output end of the inductor connected to a driver and the anode end of a diode (or series of diodes). The cathode end of the diode is connected to the positive output storage capacitor. In the storage portion of the cycle, the driver pulls the output end of the inductor to near ground to store energy in its magnetic field. In the boost portion of the cycle, the driver turns off, the inductor voltage flies high, and the inductor's stored energy is transferred through the diode to the positive output storage capacitor. When the driver senses the desired output voltage has been reached on the positive output storage capacitor, the driver may reduce the storage portion of the cycle or may skip the storage portion of the cycle until the output voltage drops below the desired regulated voltage.

When a polarity inverting negative switching power supply is typically merged with the positive boost switching power supply as described above, a transfer capacitor is also connected to the output end of the inductor. The other end of the transfer capacitor is connected to the anode end of a diode to ground and the cathode end of the diode whose anode is connected to the negative output storage capacitor. In the storage portion of the cycle, the driver pulls low to transfer charge from the transfer capacitor through the diode to the negative output storage capacitor. In the boost portion of the cycle, the driver turns off, the inductor voltage flies high, and the inductor charges the transfer capacitor through the diode to ground.

The positive output voltage can be regulated to any voltage more positive than the input supply voltage. Since only one output can be regulated in a merged boost switching power supply, the negative output voltage will not be well regulated and is somewhat dependent the output loads and on the number of diodes used in series with the capacitors. This application of the positive and negative boost switching power supply regulates to 25 volts Vpp (positive voltage) output, and approximately 24 v Vnn (negative voltage) output when one diode is used between the inductor and the positive storage capacitor. This application used a 2 MHz constant clock frequency. This driver application uses a NFET to pull the inductor output down to ground, is current limited to approximately 100 mA, and the driver is turned off when the current limit is reached (to reduce NFET power dissipation and increase efficiency). In this application, when Vpp exceeds it's regulated voltage, the driver skips the storage portion of the cycle to avoid overcharging, until the output voltage drops below the regulated voltage.

One problem with a switched power supply is at startup when the voltage on the transfer capacitor and Vnn negative output storage capacitor are low, the transfer and the negative output storage capacitor (through the diode) present a low impedance load to the driver NFET when it is on. The NFET will reach its current limit quickly, and the inductor has received little stored energy if the driver NFET is turned off when the current limit is reached. If the loads on the Vpp positive output storage capacitor or the Vnn negative output storage capacitor are large, the capacitors may not charge up, or may take a long time to charge up.

### SUMMARY OF THE INVENTION

The present invention includes a comparator which is used so that the turn off of the storage portion of the cycle by the current limit is disabled when Vpp is below approximately 75% of Vpp regulation voltage. The storage portion of the regulator cycle is forced to be equal to the storage portion of the clock cycle, so that the NFET will sink current as high as the current limit, so both the Vnn negative storage output capacitor will charge and the inductor will store energy during the charge portion of the cycle.

### BRIEF DESCRIPTION OF THE DRAWING

FIG. 1 illustrates a circuit of the present invention.

### DETAILED DESCRIPTION OF THE DRAWING

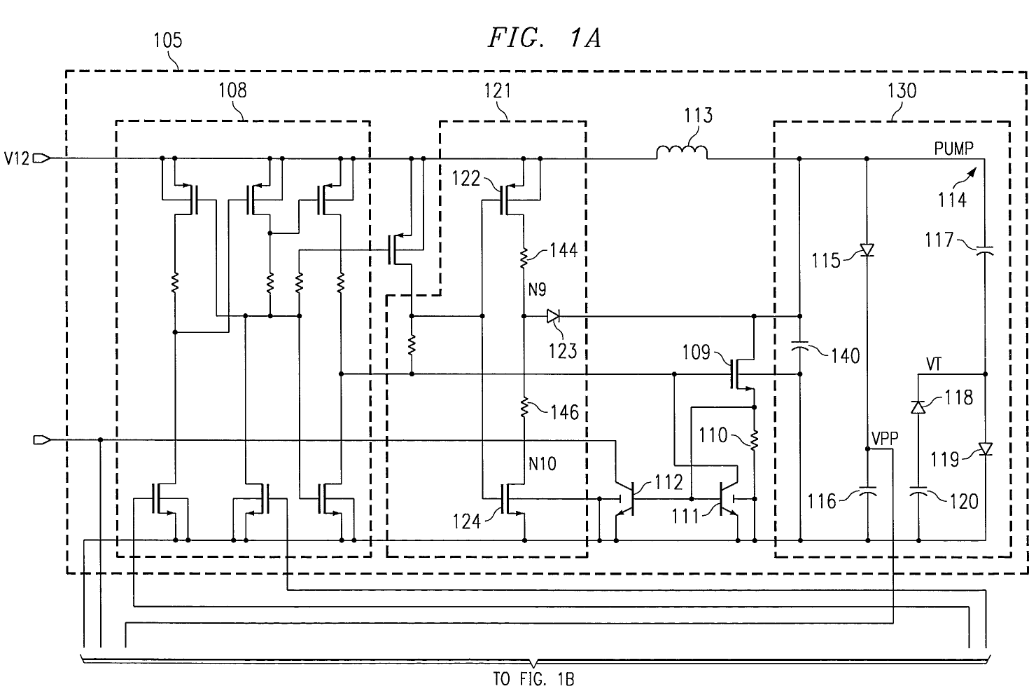

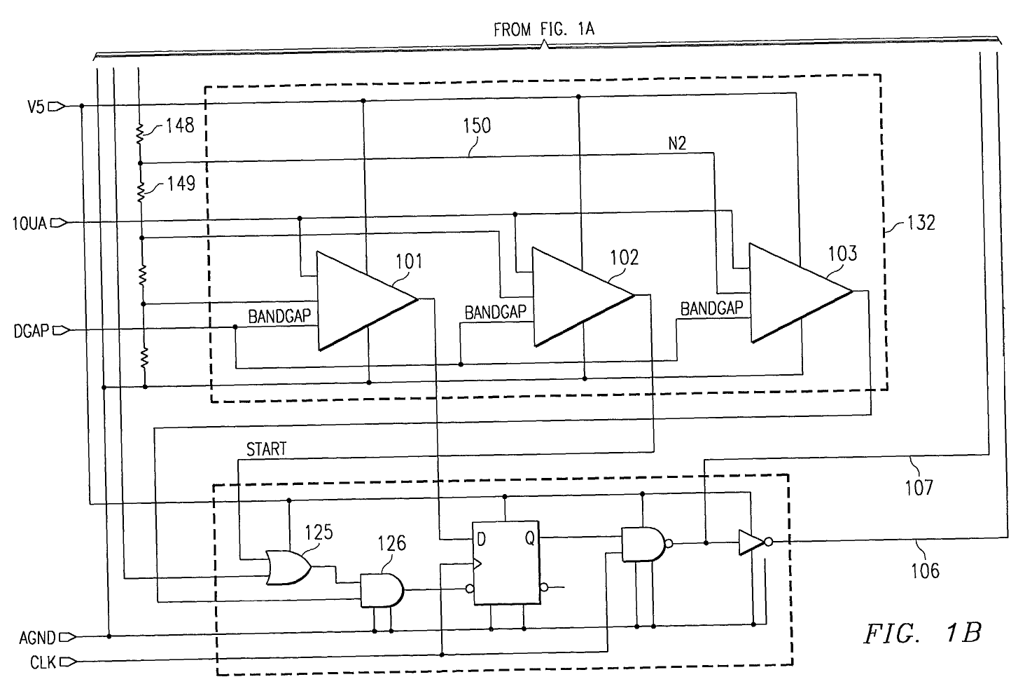

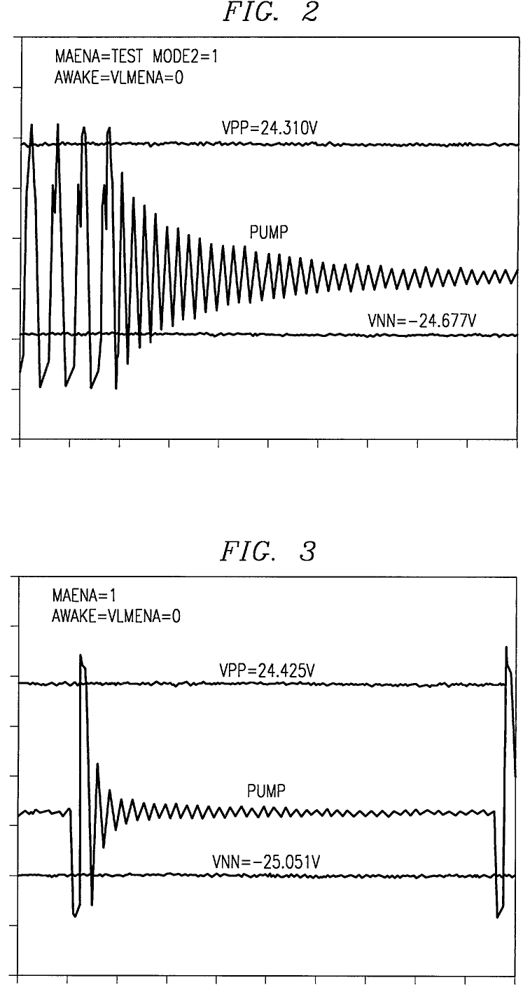

Turning now to FIG. 1, FIG. 1 illustrates a comparator circuit 132 outputs connected to a logic section 134 inputs. The logic section 134 outputs 106 and 107 are connected to a level shifting circuit 108 inputs. The level shifting circuit 108 outputs are connected to a shunt circuit 121 and a pump circuit 130 inputs. The shunt circuit 121 and pump circuit 130 common output node 114 is connected to a storage circuit 131 input. The storage circuit 131 output Vpp is connected to a comparator circuit 132 input.

The comparator circuit 132 includes a resistor 146, a resistor 147, a resistor 148, a resistor 149, a comparator 101, a comparator 102, and a comparator 103. The logic section 134 includes an OR gate 125, an AND gate 126, a D-FLIP-FLOP 127, a NAND gate 128, and an INVERTER 129. The level shifting circuit 108 includes three NFETs, four PFETs, and four resistors. The pump circuit 130 includes a NFET 109, a resistor 110, a NPN 111, and a NPN 112. The shunt circuit 121 includes a PFET 124, a PFET 122, a resistor 143, a resistor 144, a resistor 145, a diode 123, and a NFET 124. The storage circuit 131 includes an inductor 113, a diode 115, a capacitor 116, a capacitor 117, a diode 118, a diode 119, and a capacitor 120.

In operation, the current limit is used to limit the current in the NFET 109 and inductor 113 to prevent high current damage. The regulator is normally switched from the storage portion of the cycle to the transfer portion of the cycle when the current limit is reached. If the charge portion of the cycle is not ended when the current limit is reached, the limiting of the current will cause the node 114 voltage to rise, the NFET 109 will dissipate high power, and there can be low frequency ringing. If the node 114 voltage is high when the clock ends the charge portion of the cycle, the energy transferred will be less, and the system efficiency is less. The current through an inductor 113 resists change, so at the start of the storage portion of the cycle, the inductor 113 current will be low and will increase as over the storage portion of the cycle. When the Vpp and Vnn voltages are near their regulated value, the transfer capacitor 117 and Vnn negative output storage capacitor 120 will be nearly fully charged and will present a lower current load at the start of the storage portion of the cycle. The current in the inductor and therefore in the NFET 109 will increase in the charge portion of the cycle until the current limit is reached, or the charge portion of the cycle is ended by the clock.

At startup, the voltages on the transfer capacitor 117 and the Vnn negative output storage capacitor 120 are low. The voltage across a capacitor resists change, so the transfer capacitor 117 and Vnn negative output storage capacitor 120 through the diode 118 present a low impedance load to the driver NFET 109 at the start of the storage portion of the cycle. The NFET 109 will reach it's current limit quickly, and the inductor will have received little stored energy if the NFET 109 is turned off when the current limit is reached. If the startup load on the Vpp positive output storage capacitor 116 or the Vnn negative output storage capacitor 120 are large, the capacitors may not charge up, or may take a long time to charge up.

When the NFET 109 is turned off for the transfer portion of the cycle, the inductor 113 current resists change and will cause the node 114 voltage to fly high until capacitor current loading draws that amount of current out of the inductor, and the inductor current will then ramp down as the current charges the capacitors.

In the comparator circuit 132, the resistor string made up of resistor 146, resistor 147, resistor 148, and resistor 149 divides the Vpp voltage for use by the comparators to compare to a voltage from a bandgap voltage reference (not shown). Comparator 101 regulates the Vpp voltage to 25 v. Comparator 103 inhibits the storage cycle if Vpp is below approximately 50% of the input supply, which indicates a break in the Vpp connection to the comparator 103 input. Comparator 102 senses if Vpp is above approximately 75% of Vpp regulation voltage. Below Vpp at approximately 75% of Vpp regulation voltage, comparator 102 causes the NFET 109 to follow the input clock duty cycle. Above Vpp at approximately 75% of Vpp regulation voltage, comparator 102 allows the cycle to change from the storage portion of the cycle to the boost portion of the cycle when the current limit is reached or the storage portion of the clock cycle ends.

The logic section 134 puts the regulator in the storage portion of the cycle with the output 106 high and the output 107 low, and puts the regulator in the boost portion of the cycle with the output 106 low and the output 107 high. The line 105 pulled low when NFET 109 reaches it's current limit and the comparator 102 sensing Vpp is above approximately 75% of the Vpp regulation voltage into the OR gate 125, or the comparator 103 sensing the Vpp is below approximately 50% of the input supply into the AND gate 126, will clear the D-FLIP-FLOP 127 and the regulator will stay in or go to the boost portion of the cycle. The clock going high sets the D-FLIP-FLOP 127 to start the storage portion of the cycle if the comparator 103 senses Vpp is above approximately 50% of the input supply and the comparator 101 senses Vpp is below the Vpp regulation voltage. The storage portion of the cycle ends and the boost portion of the cycle begins at the first of the clock going low or the clearing of the D-FLIP-FLOP 127 by AND gate 126.

The level shifting circuit 108 is used to convert the 5v signals from the logic section 134 to 12 v signals needed by the shunt circuit 121 and the pump circuit 130, for example and other voltages could be used.

The pump circuit 130 sinks current from the inductor 113 and the transfer capacitor 117. A current source to 5 v (not shown) is connected as a pull-up to the collector 105 of NPN 112. The collector of NPN 111 is connected to the gate of NFET 109. The bases of NPN 111 and NPN 112 are connected to the source of NFET 109 and the resistor 110. When the NFET 109 is conducting in the storage portion of the cycle and the current through the resistor 110 causes a voltage of approximately 0.72 v on the bases of NPN 111 and NPN 112, NPN 111 and NPN 112 turn on indicating the current limit has been reached. NPN 112 pulls the gate of NFET 109 to a lower voltage to limit the NFET 109 current and NPN's 111 collector pulls 105 low. If comparator 102 senses Vpp is above approximately 75% of Vpp regulation voltage, the logic section 134 will cause NFET 109 to turn off starting the boost portion of the cycle.

When NFET 109 is conducting for the storage portion of the cycle, current is drawn from the input supply through the inductor 113 to build up the inductor's storage field, and through the series of transfer capacitor 117, Vnn diode 118, and Vnn negative output storage capacitor 120 to build up the negative charge on Vnn negative output storage capacitor 120. When NFET 109 is turned off for the boost portion of the cycle, the inductor 113 output node 114 voltage flies high, and the inductor's storage field drives current through the diode 115 to build up the charge on the Vpp positive output storage capacitor 116, and through the series of the transfer capacitor 117 and the diode 119 to build up the voltage on the transfer capacitor 117. The highest voltage on node 114 will be the Vpp regulation voltage on the Vpp positive output storage capacitor 116 plus the voltage drop of diode 115, and also the voltage on the transfer capacitor 117 plus the voltage drop of diode 119. The highest voltage that can be transferred to the Vnn negative output storage capacitor 120 is the transfer capacitor 117 voltage minus the drop of diode 118. In the circuit shown, the magnitude of Vnn negative voltage will be approximately 1 diode drop less than and not more than the positive voltage of Vpp. Vnn is unregulated and will change with the loading on Vpp and Vnn. Diodes can be added in series with the shown diodes to effect the relationship between Vpp and Vnn.

1. A power supply circuit for generating a regulated voltage, comprising:
a pump circuit to boost said voltage by employing a charge cycle;
a storage circuit to store said voltage;
a control circuit to regulate said storage of said voltage;
a detection circuit to detect the end of the charge cycle and a current limit;
a detection circuit to detect said stored voltage level; and
wherein said control circuit continues to store voltage in said storage circuit for a predetermined period of time after said current level has been reached.

2. A power supply circuit for generating regulated voltages as in claim 1, wherein said storage circuit includes an inductor.

3. A power supply circuit for generating regulated voltages as in claim 2, wherein said storage circuit includes a voltage storage capacitor.

4. A power supply circuit for generating regulated voltages as in claim 2 and claim 3, wherein said pump circuit includes NFET to sink current from said inductor and capacitor.

5. A power supply circuit for generating regulated voltages as in claim 1, wherein said control circuit includes an comparator.

6. A power supply circuit for generating regulated voltages as in claim 3 and claim 5, wherein said comparator senses said low capacitor voltage.

7. A power supply circuit for generating regulated voltages as in claim 4 and claim 6, wherein said comparator controls said NFET current sink time.
